(19) United States
(12) Patent Application Publication
(10) Pub. No.: US 2015/0203366 A1
(43) Pub. Date: Jul. 23, 2015

(54) REVERSIBLE TRAPPING ON ACTIVATED CARBON

(71) Applicants: CENTRE NATIONAL DE LA RECHERCHE SCIENTIFIQUE, Paris (FR); UNIVERSITY D'ORLEANS, Orleans (FR)

(72) Inventors: Sandrine Delpeux-Ouldriane, Chateauneuf sur Loire (FR); Francois Beguin, Olivet (FR)

(73) Assignee: CENTRE NATIONAL de la RECHERCHE SCIENTIFIQUE, Paris (FR)

(21) Appl. No.: 14/422,215

(22) PCT Filed: Aug. 19, 2013
(86) PCT No.: PCT/EP2013/067241

§ 371 Date: Feb. 18, 2015

(30) Foreign Application Priority Data
Aug. 20, 2012 (FR) 1257895

(51) Int. Cl. C02F 1/28

(52) U.S. Cl. CPC C02F 1/281; C02F 2101/306

(57) ABSTRACT

A cyclic process is provided for reversible adsorption of emerging pollutants or micropollutants for depolluting a contaminated aqueous medium. The process is carried out without oxygen-containing gas, and without the provision of radical initiators, and includes a plurality of cycles, each cycle having the following steps: a. the adsorption of the emerging pollutants and micropollutants contained in the aqueous medium onto an activated carbon felt electrode by bringing the contaminated aqueous medium into contact with the activated carbon felt electrode making it possible to adsorb the emerging pollutants and micropollutants contained in the aqueous medium onto the activated carbon felt electrode; and b. the in situ regeneration of the activated carbon felt electrode by negative polarization allowing the electrochemical desorption of the emerging pollutants and micropollutants adsorbed in step a) and the re-use of the activated carbon felt electrode in the next cycle, and use thereof for depolluting aqueous media.

A subject of the present invention is a cyclic process for the reversible adsorption on activated carbon of emerging pollutants or micropollutants for the depollution of a contaminated aqueous medium, a device for the implementation of this process and its application for the depollution of aqueous media, in particular for the depollution of water.

For several years, pollution of surface and subsurface water has been increasing. Major pollution, linked to human activity, is constituted by industrial waste (metals, colorants, chemicals), pharmaceuticals (veterinary products and therapeutic molecules such as antibiotics, antineoplastics and synthetic hormones) and phytosanitary products (surfactants, agricultural treatment products).

The latter includes the family of pesticides, which are flagship products of the intensive agriculture of the last fifty years, comprising more than 400 molecules. Today, toxicological studies show the adverse effects of these substances on the environment and their long term noxiousness, even for minute doses. They are generally toxic to aquatic life and some have a known carcinogenic character. Moreover, a good number of these stable and very soluble pollutants are capable of diffusing very rapidly in the environment. Their periods of persistence of activity are dangerously long, of the order of half a century and moreover they are very resistant to the biological treatments used in waste water treatment units. It is therefore vital to develop increasingly sophisticated water purification methods.

Much research work has been undertaken both at a national level and at a European level to develop such methods. Thus in CEMAGREF's Ampère project, the methods used are based on mass spectrometry, gas chromatography and extraction on solid phase and do not make it possible to go below a concentration of the order of ng/L (http://projectamperes.cemagref.fr/_illustrations/3-Methodoanalyse_amperes_coquery_janv10.pdf).

Activated carbons, which have very extended accessible surfaces and are constituted by small-sized pores, are excellent candidates as adsorbents of the volatile organic compounds present in the atmosphere but also as adsorbents at the end of the water depollution system. In fact, they have a wide adsorption spectrum and in particular very good adsorption capacities in the liquid phase, for pollutants of nanometric size present as traces. However, the adsorption of organic micropollutants on the activated carbons is carried out in the main by a chemical mechanism via high energy dispersive interactions, which makes the process effective but irreversible.

The regeneration of the activated carbons therefore constitutes a challenge both technical and economic, which aims to optimize the durability of the carbon-containing absorbents. The current regeneration technique by thermal route, in the presence or absence of a reactive gas or steam, are processes which are both expensive and partially destructive, which inevitably lead to the progressive obstruction of the porosity. They cannot be implemented in situ, which clearly reduces their scope.

Thus U.S. Pat. No. 5,904,832 describes a method for the regeneration of activated carbon after adsorption of pollutants comprising a step of desorption and a step of decomposition of said pollutants simultaneously. The authors worked under polarization with the addition of radical initiators, which leads to the production of radicals (FENTON process) capable of degrading the pollutants while desorbing them and regenerating the porosity.

A. Alfarra, et al. (Electrochimica Acta, (2002), 47, 1545-1553) have shown that an activated carbon can reversibly trap cations such as lithium. Under the effect of a negative electric polarization, the lithium is adsorbed, then it is released by reversing the polarization. The microporous carbon then plays the role of an ion exchange resin and the surface groups of the adsorbent are responsible for trapping the cations.

On the basis of these results, the inventors have shown that the use of these electrochemical processes can be widened to bentazone, an ionisable organic molecule. In its neutral form, the bentazone is adsorbed exclusively by dispersive interactions and the adsorption process is spontaneous. When the bentazone is anionic, its displacement towards the higher adsorption sites such as the narrow micropores is promoted. The adsorption kinetics of bentazone are clearly reduced when it is anionic and the surface of the activated carbon comprises acid functions, especially when they are dissociated. When the bentazone is neutral, the adsorption kinetics are also affected in so far as the introduction of surface groups reduces the extent of the conjugated system of the activated carbon and partially obstructs access to the micropores. The process of electrochemical desorption of the bentazone under cathodic polarization allows genuine regeneration of the porosity of the adsorbent carbon cloth (Sandrine Delpeux-Ouldriane, Impact d'une polarisation électrochinnique pour le piégeage réversible de la Bentazone sur carbones nanoporeux [Impact of a electrochemical polarization for the reversible trapping of Bentazone on nanoporous carbons]. Thesis 29 Nov. 2010 ftp://ftp.univ-orleans.fr/theses/_sandrine.delepeux_{—}1879_vm.pdf).

While continuing their research, the Inventors surprising found that carbon felts, although known for their mediocre conductive properties, could be used in such electrochemical processes.

Also a subject of the invention is a cyclic process for the reversible adsorption of emerging pollutants or micropollutants for the depollution of an aqueous medium contaminated with said emerging pollutants or said micropollutants, said process being carried out without a supply of gas containing oxygen, without a supply of radical initiators, and comprising a plurality of cycles, each cycle comprising the following steps:
a. the adsorption of said emerging pollutants and micropollutants contained in said aqueous medium on an activated carbon felt electrode by bringing said contaminated aqueous medium into contact with said activated carbon felt electrode, making it possible to adsorb said emerging pollutants and micropollutants contained in said aqueous medium on said activated carbon felt electrode, and
b. the in situ regeneration of said activated carbon felt electrode by negative polarization allowing the electrochemical desorption of said emerging pollutants and micropollutants adsorbed in step a) and the reuse of said activated carbon felt electrode in the following cycle.

Within the meaning of the present invention by “carbon felt” is meant a flexible material made of activated carbon fibres which are stacked in a random fashion; these are very inexpensive materials unlike the materials obtained by carbonization/activation of cloths made of phenolic resin fibres. In comparison to carbon cloths, the felts have a lower mechanical resistance; they can therefore be rolled more easily thus making it possible to have a great deal of material for a small volume and be used for example to make cartridges.

According to the invention, the conductivity of the aqueous medium is advantageously greater than 2.5 mS/cm. In general, the conductivity of the water to be treated is of order of 10 mS/cm, therefore much greater than the minimum value necessary. If the natural conductivity of the medium to be treated is not sufficient, i.e. less than 2.5 mS/cm, then the addition of a conductive salt makes it possible to reach the values necessary for the implementation of the process. In this case the concentration of conductive salt in said aqueous medium is in general less than 1 M, advantageously comprised between 0.01 M and 0.1 M.

According to the invention, there are two variants in the process.

In a first variant the process is purely reversible, without degradation of the pollutants and allows the recovery of the pollutants intact; these are then recovered in a cyclic manner then reclaimed or subsequently destroyed by processes known to a person skilled in the art. This variant has the advantage of not generating by-products and of not altering at all the adsorbent carbon which is regenerated in an optimum manner. The desorption/regeneration cycle can be very short, of the order of 30 mn to 90 mn. There is no addition of radical initiator, nor bubbling oxidizing gas through the electrolyte and the counter electrode is made of carbon which is slightly porous or non-porous (carbon cloth or felt, glassy carbon, recompressed exfoliated graphite or carbon doped with boron).

In a second variant the process comprises, after the step of desorption, a step of degrading the pollutants. The pollutants are desorbed from the pores under negative polarization then degraded on contact with the metal counter electrode, advantageously made of stainless steel or platinum. This operation requires a longer contact time, in general a few hours, for a more complete degradation depending on the pollutants.

Thus, in an advantageous embodiment of the invention, the cyclic process comprises, after step b):
either a step of recovering said emerging pollutants and micropollutants desorbed in step b), which can then be upcycled and/or assayed,
or a step of degrading said emerging pollutants or said micropollutants by oxidation.

The steps of recovery, assay and degradation are carried out by any technique known to a person skilled in the art and are adapted to the nature of the substance concerned.

In another advantageous embodiment of the invention, the cyclic process is carried out continuously.

In another embodiment of the invention, the aqueous medium is maintained under stirring during the adsorption phase in order to increase the adsorption rates of said pollutants on the felt cartridge.

In another embodiment of the invention, said micropollutants or emerging pollutants are the pollutants described in Directive 2008/105/EC of the European Parliament and of the Council of 16 Dec. 2008 on environmental quality standards in the field of water policy (http://eur-lex.europa.eu/LexUriServ/LexUriServ.do?uri=OJ:L:2008:348:0084:0097:FR:PDF Annex I and X). They are advantageously selected from the group comprising medicinal products, phytosanitary products, heavy metals, colorants, plastic additives and phenolic derivatives. There can be mentioned by way of example bisphenol A, paracetamol, diclofenac, ibuprofen, clofibric acid, mecoprop, pentachlorophenol, diclofenac and hormones.

In an advantageous embodiment of the invention, the sheet of activated carbon has:
a. a specific surface area of at least 800 m²/g, advantageously greater than 1000 m²/g,
b. a density comprised between 100 and 1000 g/m², advantageously between 200 and 500 g/m², even more advantageously between 300 and 400 g/m²
c. a microporosity comprised between 0.7 and 2 nm, a mesoporosity comprised between 5 and 10 nm and a macroporosity greater than 50 nm.

In another advantageous embodiment of the present invention, the activated carbon felt has ionizable active acid sites (dissociated anionic groups such as the phenates and carboxylates) at the surface, of the order of 0.5-5 mmoles/g, advantageously 0.5-3 mmoles/g, even more advantageously 0.5-1 mmole/g.

The duration of step a) is not crucial and can be comprised between 1 hour and 23 hours or last several days or several weeks, depending on the effluents treated and their level of micropollutants; ideally it is such that saturation is not reached.

The duration of step b) is comprised between 30 minutes and 2 hours, advantageously equal to 1 hour.

In a particularly advantageous embodiment of the invention, step b) is carried out by the application of a negative current with a charge density from 10 mA/g to 1 A/g of felt, advantageously from 100 to 300 mA/g of felt.

The cyclic process according to the invention can be used for the decontamination or the depollution of any aqueous medium contaminated, in particular, with waste water, hospital waste, sewage treatment plant effluents, industrial effluents, leachates and underground water.

Also a subject of the present invention is a method for the depollution of an aqueous medium, in particular a method for the depollution of water, in particular of a contaminated aqueous medium selected from the group comprising waste water, hospital waste, sewage treatment plant effluents, industrial effluents, leachates and underground water, said method comprising the implementation of the process or the device according to the invention.

Also a subject of the invention is a device for the depollution of an aqueous medium contaminated with emerging pollutants or by micropollutants, comprising an activated felt electrode, supply means allowing the aqueous medium to be brought into contact with said activated felt electrode in order to adsorb said emerging pollutants or micropollutants contained in said aqueous medium, means for applying a negative polarization to said activated felt electrode, said means being arranged in order to implement the process of the invention.

In an advantageous embodiment of the invention, the device is an electrochemical cell also comprising a counter-electrode selected from electrodes made of carbon which is slightly porous or non-porous (carbon cloth or felt, glassy carbon, recompressed exfoliated graphite or carbon doped with boron) and metal electrodes made of stainless steel or platinum.

The selection of counter-electrode depends on the variant of the process used and the nature of the pollutant or pollutants concerned. In the first variant where degrading the products is not desired, then the counter-electrode is an electrode made of carbon which is slightly porous or non-porous as described previously. In the second variant, the counter-electrode will be a metal electrode, contact with which will degrade the pollutants. The degradation reaction can be continued until degradation of the desorbed pollutant is complete, the time required depending on the molecule to be treated (between two hours and 12 hours).

The process according to the invention can be used with media comprising several pollutants without there being competition between the different pollutants present. Moreover the presence of natural organic matter, such as humic acid for example, does not interfere with the measurements which makes the process of the invention particularly effective and competitive.

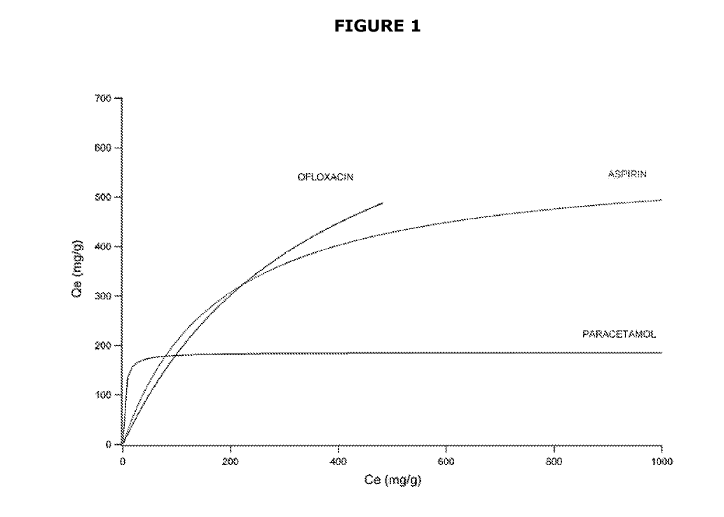

FIGS. 1 to 5 and Examples 1 to 6 which follow illustrate the invention.

FIG. 1 represents the absorption isotherms of ofloxacin, aspirin and paracetamol as measured according to Example 1. Qₑ represents the quantity of pollutant absorbed per mass of carbon and Cₑ the concentration of pollutant at equilibrium.

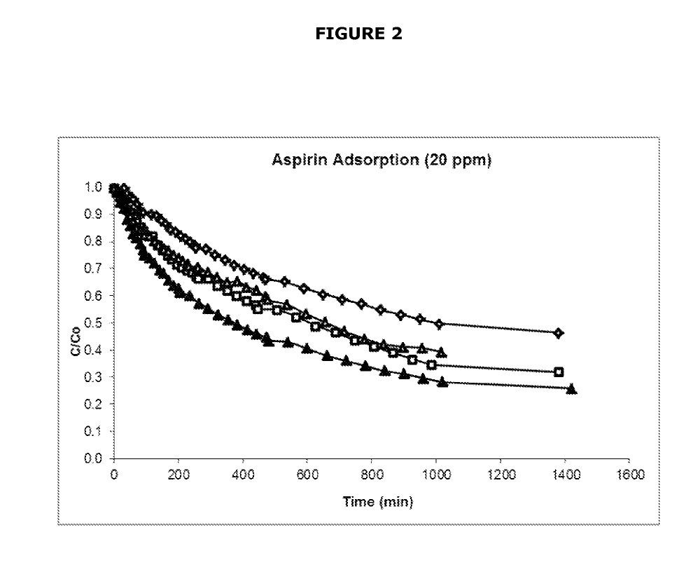

FIG. 2 represents the adsorption kinetics of aspirin on three activated carbon cloths (□), (⋄) and (Δ) the respective specific surface areas of which are 1350 m²/g, 1150 m²/g and 1150 m²/g and on a felt with a density of 1000 m²/g (▴) as measured according to Example 2. C/Cₒ represents the ratio between the concentration of pollutant at time t of the adsorption process (C) and the initial concentration of pollutant (Cₒ).

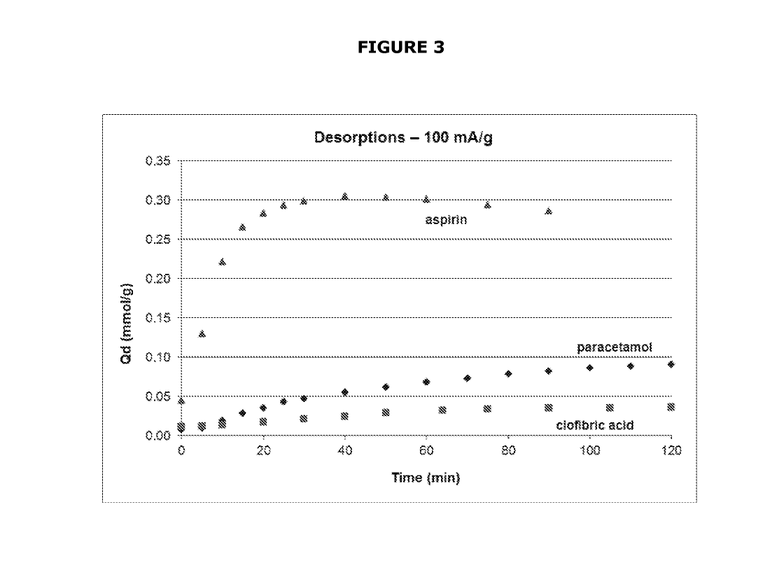

FIG. 3 represents the desorption kinetics of aspirin (▴), paracetamol (♦) and clofibric acid (▪) measured according to Example 3. Q_{d} represents the quantity of pollutant desorbed per mass of carbon.

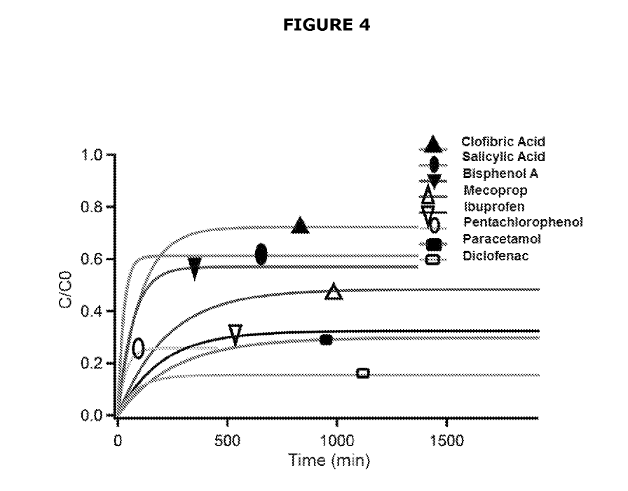

FIG. 4 represents the desorption kinetics of salicylic acid (), clofibric acid (▴), mecoprop (Δ), bisphenol A (▾), pentachlorophenol (◯), diclofenac (□), paracetamol (▪) and ibuprofen (∇). C/Cₒ represents the ratio between the concentration of pollutant at time t of the adsorption process (C) and the initial concentration of pollutant (Cₒ)

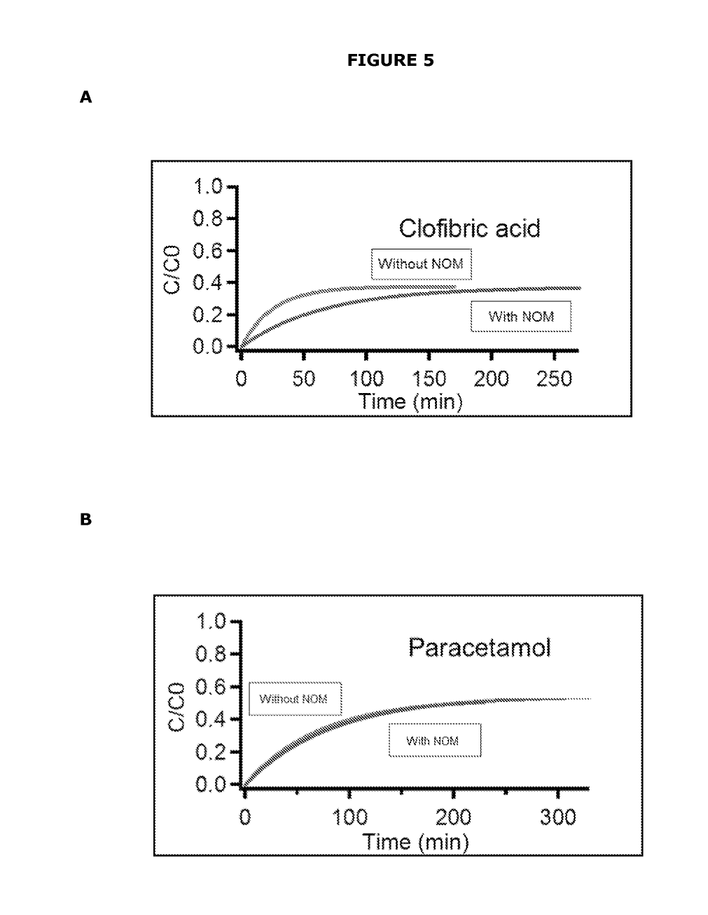

FIG. 5 represents the desorption kinetics of clofibric acid (FIG. 5A) and paracetamol (FIG. 5B) alone (without NOM) or in the presence of natural organic matter (with NOM). C/Cₒ represents the ratio between the concentration of pollutant at time t of the adsorption process (C) and the initial concentration of pollutant (Cₒ)

### EXAMPLE 1

### Adsorption Isotherms

1.1. Preparations of electrolytic solutions Solutions containing 20 ppm of pollutant were prepared by weighing. The adsorption equilibria and kinetics were carried out in an Na₂SO₄ 0.01 mol/L medium (pH 6.5), which is moreover a value close to the pH of the natural effluents to be reprocessed (of the order of 7). The conductivity must be a minimum of 2.5 mS/cm.

1.2. Adsorption Isotherms

The adsorption isotherms were determined according to the so-called batch analysis technique. Pieces of activated carbon felt with a specific surface area equal to 1000 m²/g, which were washed and dried beforehand, with variable masses (2-100 mg), are placed in a solution of pollutant. The concentration of pollutant was fixed at 20 mg/L and the volume of the solution is 50 ml.

The samples are placed under stirring at 23° C. (+/−2° C.) for 72 hours, which is the time required to reach equilibrium.

The residual concentrations of pollutant in solution at equilibrium are measured by spectroscopy in the UV range at maximum adsorption wavelengths, in quartz cells with an optical path of 2 or 10 mm. The quantity of pesticide adsorbed at equilibrium per mass of carbon Qₑ is calculated by the difference according to the equation:

Qₑ(mg/g)=V·(Cₒ−Cₑ)/m

where V is the volume of solution of pollutant, Cₒ and Cₑ are the concentrations of pollutant in solution initially and at equilibrium respectively in ring/1 and m is the mass of the activated carbon felt in g.

The adsorption isotherms of two antalgesics, aspirin and paracetamol, and an antibiotic, ofloxacin, are given in FIG. 1.

Table 1 below shows the adsorption capacities Qm determined according to the Langmuir model.

TABLE 1

| | | | | Constant |
|---|---|---|---|---|
| | | | | linked to the |
| | | Solubility in | | heat of |
| Molecule | pKa | water (mg/L) | Q_{M} (mg/g) | adsorption (B) |
| Ofloxacin | 8 | 3000 | 866 | 0.003 |
| Aspirin | 3.5 | 3000 | 582 | 0.006 |
| Paracetamol | 9.4 | 14000 | 186 | 0.303 |

The more the molecule is not dissociated and the lower its solubility, the higher the adsorption capacities.

### EXAMPLE 2

### Adsorption Kinetics of Aspirin

The adsorption kinetics are carried out on carbon felts with a specific surface area equal to 1000 m²/g, previously cut out (14 mm diameter disk), weighed, then impregnated with the support solution (without pollutant) for a minimum period of 24 hours. In this way, the porous surface is perfectly wetted by the solvent.

Then, the felt disks are immersed in the solution containing the pollutant (aspirin at 20 ppm), under constant stirring. A UV-visible spectrometer provided with a circulation quartz cell connected to a peristaltic pump, makes it possible to measure the reduction in concentration of pollutant continuously, without taking samples. For the first hour, the measurements are carried out every ten minutes, then every thirty minutes. After eight hours, the measurements are carried out every hour.

The results are given in FIG. 2.

The felts show adsorption kinetics which are much more rapid than those of carbon cloths with a very high specific surface area.

These results show that due to its structure the carbon felt has transfer properties much superior to those of carbon cloths, which themselves are already much better than those of powdered activated carbons. Moreover, the felts, due to their structure, should show a less significant loss of charge when they are used in dynamic adsorption processes in solution. These materials could therefore be used in high-flow dynamics without the risk of clogging and pressure fluctuations which could damage the adsorbent material and therefore obstruct the operation of the system.

### EXAMPLE 3

### Desorption Under Polarization/Regeneration of the Porosity

In the laboratory cell, the current collector is a plate in or on which the carbon felt is fixed by means of a link constituted by a nylon wire. The auxiliary electrode is a platinum basket.

The reference electrode Hg/Hg₂SO₄ operates with a saturated solution of K₂SO₄ as internal electrolyte, which gives it a reference potential of E=0.649 V vs. SHE. In order to avoid any diffusion of the electrolyte, the reference electrode is equipped with an electrode extension.

The synthetic mixture (pollutant+water) not being sufficiently conductive, a chemically inert conductive salt Na₂SO₄ is added at a concentration of 0.01 mol/L. The pH of the solution is then approximately 6-6.2 and the conductivity 2.5 mS/cm (the conductivity of the natural effluents is sufficient and does not require the addition of salt).

The polarization is applied at the level of the work electrode made of carbon felt using a multichannel generator/recorder VMP-1 (BIOLOGIC). The polarizations are carried out in galvanostatic mode (constant current). A negative polarization of −100 to −300 mA/g is applied for a given period of time and the evolution of the potential at the work electrode as a function of the time is recorded.

The desorption level varies between 50 and 100% depending on the nature of the pollutant. The desorption rates also vary as a function of the current density applied and the nature of the pollutant (from a few minutes to a few hours).

The results obtained with a polarization of −100 mA/g for 120 minutes are given in FIG. 3 for aspirin, paracetamol and clofibric acid. The aspirin has a desorption level greater than 95% and very rapid kinetics. For certain molecules which have a high pKa (paracetamol) or are slightly soluble (clofibric acid), the desorption levels are of the order of 50% and the desorption kinetics are slower. In fact, these results are linked to the degradation of these products in contact with the platinum electrode (see Example 4).

### EXAMPLE 4

### Influence of the Nature of the Counter-Electrode

The reversible desorption levels and the degradation levels are measured for clofibric acid for two types of counter electrode: platinum and glassy carbon (non-porous carbon) for a cathodic polarization applied for 120 minutes (−10 mA, Na₂SO₄ 0.01 M, microporous carbon work electrode).

The desorption and degradation levels were determined by HPLC.

The results are shown in Table 2 below.

TABLE 2

| Nature of the Counter | Reversible desorption | |
|---|---|---|
| Electrode | level (%) | Degradation level (%) |
| Platinum | 20 | >70 |
| Glassy carbon | >80 | <2 |

These results show that in the presence of a carbon counter electrode, the clofibric acid reversibly desorbs without being altered or oxidized with a regeneration level which exceeds 80% in less than two hours.

If platinum is used in the counter electrode (positive electrode), the clofibric acid, once it is desorbed, comes into contact with the positively charged counter electrode which catalyses a rapid oxidation of the clofibric acid (70% in two hours).

### EXAMPLE 5

### Desorption Kinetics in a Mixture of Different Pollutants

The desorption kinetics of the different pollutants contained in a synthetic mixture (water+different pollutants: clofibric acid, mecoprop, bisphenol A, pentachlorophenol, diclofenac, paracetamol and ibuprofen) are measured under the following conditions: −10 mA, Na₂SO₄ 0.01 M, mesoporous carbon work electrode, platinum counter electrode.

The results are given in FIG. 4.

They show that there is no phenomenon of competition to the desorption. The regeneration levels observed for each pollutant in the mixture are identical to those observed individually for each pollutant.

### EXAMPLE 6

### Desorption Kinetics in the Presence of Natural Organic Matter

Two synthetic mixtures (water+clofibric acid) and (water+paracetamol), each mixture containing well water as natural organic matter (NOM) at a rate of 90 mg of carbon originating from NOM per gram of carbon-containing adsorbent, are studied under the following conditions: −10 mA, Na₂SO₄ 0.01 M, microporous carbon work electrode, platinum counter electrode.

The results are given in FIG. 5.

No effect of competition to the desorption is observed with the target pollutants (FIG. 5A clofibric acid; Figure B paracetamol). If the natural organic matter slows down the adsorption of the emerging pollutants (known effect), it does not stop the desorption under polarization, only a slight slowing down of the desorption kinetics is observed.

NOM being present in the majority of the natural effluents, these results illustrate the feasibility of the process on real media which are lightly loaded.

1. A cyclic process for the reversible adsorption of emerging pollutants or micropollutants for the depollution of an aqueous medium contaminated with said emerging pollutants or said micropollutants, said process being carried out without a supply of gas containing oxygen, without a supply of radical initiators, and comprising a plurality of cycles, each cycle comprising the following steps:
a. the adsorption of said emerging pollutants and micropollutants contained in said aqueous medium on an activated carbon felt electrode by bringing said contaminated aqueous medium into contact with said activated carbon felt electrode making it possible to adsorb said emerging pollutants and micropollutants contained in said aqueous medium on said activated carbon felt electrode; and
b. the in situ regeneration of said activated carbon felt electrode by negative polarization allowing the electrochemical desorption of said emerging pollutants and micropollutants adsorbed in step a) and the reuse of said activated carbon felt electrode in the following cycle.

2. The cyclic process according to claim 1 characterized in that it comprises, after step b),
either a step of recovering said emerging pollutants and micropollutants desorbed in step b);
or a step of degrading said emerging pollutants or said micropollutants by oxidation.

3. The cyclic process according to claim 1 characterized in that the process is carried out continuously.

4. The cyclic process according to claim 1 characterized in that the aqueous medium is preferably maintained under stirring during the adsorption phase in order to accelerate the process.

5. The cyclic process according to claim 1 characterized in that said micropollutants or emerging pollutants are the pollutants described in Directive 2008/105/EC of the European Parliament and of the Council of 16 Dec. 2008 on environmental quality standards in the field of water policy.

6. The cyclic process according to claim 1 characterized in that said micropollutants or emerging pollutants are selected from the group comprising medicinal products, phytosanitary products, heavy metals, colorants, plastic additives and phenolic derivatives.

7. The cyclic process according to claim 1 characterized in that the activated carbon felt has:
a. a specific surface area of at least 800 m²/g, advantageously greater than 1000 m²/g;
b. a density comprised between 100 and 1000 g/m², advantageously between 200 and 500 g/m², even more advantageously between 300 and 400 g/m²; and
c. a microporosity comprised between 0.7 and 2 nm, a mesoporosity comprised between 5 and 10 nm and a macroporosity greater than 50 nm.

8. The cyclic process according to claim 1 characterized in that the activated carbon felt has ionizable active acid sites at the surface of the order of 0.5-5 mmoles/g, advantageously 0.5-3 mmoles/g, even more advantageously 0.5-1 mmole/g.

9. The cyclic process according to claim 1 characterized in that the duration of step b) is comprised between 30 minutes and 2 hours, advantageously equal to 1 hour.

10. The cyclic process according to claim 1 characterized in that step b) is carried out by the application of a negative current with a charge density of 10 mA/g to 1 A/g of felt, advantageously 100 to 300 mA/g of felt.

11. The cyclic process according to claim 1 characterized in that the contaminated aqueous medium is selected from the group comprising waste water, hospital waste, sewage treatment plant effluents, industrial effluents, leachates and underground water.

12. The Cyclic process according to claim 1 characterized in that the process is purely reversible, without degradation of the pollutants and in that the counter electrode is made of carbon which is slightly porous or non-porous, in particular carbon cloth or felt, glassy carbon, recompressed exfoliated graphite or carbon doped with boron.

13. The cyclic process according to claim 2 characterized in that the degradation of the pollutants is carried out by contact with the counter electrode made of metal, advantageously made of stainless steel or platinum.

14. A method for the depollution of an aqueous medium, in particular a method for the depollution of water comprising the implementation of the process according to claim 1.
